(19) United States
(12) Patent Application Publication
(10) Pub. No.: US 2026/0114362 A1
(43) Pub. Date: Apr. 30, 2026

(54) SWITCH FOR MANUAL OR REMOTE OPERATION OF A RIDING LAWN CARE VEHICLE

(71) Applicant: HUSQVARNA AB, Huskvarna (SE)

(72) Inventors: Mats AXELSSON, Huskvarna (SE); Einar ANDERSSON, Huskvarna (SE)

(21) Appl. No.: 19/489,676

(22) PCT Filed: Oct. 11, 2023
(86) PCT No.: PCT/IB2023/060241

§ 371 Date: Dec. 3, 2025

(51) Int. Cl. A01D 34/00; G05D 1/227; G05D 105/15; G05D 107/20; G05D 109/10

(52) U.S. Cl. CPC A01D 34/006; G05D 1/227; G05D 2105/15; G05D 2107/23; G05D 2109/10

(57) ABSTRACT

A mode switching assembly for switching a riding lawn care vehicle between a manual mode of operation and a remote mode of operation may include a manual input bracket that receives a manually applied speed control from a local operator at the riding lawn care vehicle, a remote input bracket that receives a remotely applied speed control from a remote operator relative to the riding lawn care vehicle, an output bracket that drives a speed of the riding lawn care vehicle based on an input to a selected one of the manual input bracket or the remote input bracket, and a selection assembly operably coupling the selected one of the manual input bracket or the remote input bracket to the output bracket to define the manual and remote modes of operation. The selection assembly may include a biasing assembly to bias the selection assembly such that, by default, the output bracket is operably coupled to the manual input bracket.

### TECHNICAL FIELD

Example embodiments generally relate to lawn care vehicles and, more particularly, relate to a riding lawn care vehicle that can alternately be operated in a manual or remote mode, and the equipment that enables switching therebetween.

### BACKGROUND

Lawn care tasks are commonly performed using various tools and/or machines that are configured for the performance of corresponding specific tasks. Certain tasks, like grass cutting, are typically performed by lawn mowers that may come in many different sizes and may have wide variances in their capabilities. However, beyond mere changes in size and function, riding lawn care vehicles can also be produced with variation in how they are operated (e.g., autonomously, remotely or manually). In the past, remotely controllable lawn mowers (e.g., robotic lawn mowers) have typically been rather small, and larger riding lawn care vehicles have typically required manual operation.

The improvements that continue to be made in relation to battery technology and wireless communication may provide opportunities for ever larger vehicles to be operated remotely instead of just manually. However, in order to facilitate changing between these different modes, a reliable architecture for mode switching may be desirable. Example embodiments may provide just such an architecture.

### BRIEF SUMMARY OF SOME EXAMPLES

In an example embodiment, a riding lawn care vehicle is provided. The riding lawn care vehicle may include a frame to which wheels of the riding lawn care vehicle are attachable, and a steering assembly operably coupled to one or more of the wheels of the riding lawn care vehicle to provide steering inputs to the one or more of the wheels by an operator of the riding lawn care vehicle and a mode switching assembly. The mode switching assembly may include a manual input bracket that receives a manually applied speed control from a local operator at the riding lawn care vehicle, a remote input bracket that receives a remotely applied speed control from a remote operator relative to the riding lawn care vehicle, an output bracket that drives a speed of the riding lawn care vehicle based on an input to a selected one of the manual input bracket or the remote input bracket, and a selection assembly operably coupling the selected one of the manual input bracket or the remote input bracket to the output bracket to define the manual and remote modes of operation. The selection assembly may include a biasing assembly to bias the selection assembly such that, by default, the output bracket is operably coupled to the manual input bracket.

In another example embodiment, a mode switching assembly for switching a riding lawn care vehicle between a manual mode of operation and a remote mode of operation is provided. The mode switching assembly may include a manual input bracket that receives a manually applied speed control from a local operator at the riding lawn care vehicle, a remote input bracket that receives a remotely applied speed control from a remote operator relative to the riding lawn care vehicle, an output bracket that drives a speed of the riding lawn care vehicle based on an input to a selected one of the manual input bracket or the remote input bracket, and a selection assembly operably coupling the selected one of the manual input bracket or the remote input bracket to the output bracket to define the manual and remote modes of operation. The selection assembly may include a biasing assembly to bias the selection assembly such that, by default, the output bracket is operably coupled to the manual input bracket.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a perspective view of a riding lawn care vehicle according to an example embodiment;

FIG. 2 illustrates a block diagram of a mode switching assembly according to an example embodiment;

FIG. 3 illustrates a perspective view of various components forming the mode switching assembly according to an example embodiment;

FIG. 4 illustrates a side view of a manual input bracket according to an example embodiment;

FIG. 5 illustrates a side view of a remote input bracket according to an example embodiment;

FIG. 6 illustrates a side view of an output bracket according to an example embodiment;

FIG. 7 illustrates a perspective view of components of a selection assembly according to an example embodiment;

FIG. 8 illustrates a side view of various components of the mode switching assembly according to an example embodiment;

FIG. 9 illustrates a side view of the selection assembly in a manual mode according to an example embodiment; and

FIG. 10 illustrates a side view of the selection assembly in a remote mode according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Some example embodiments may provide a mode switching assembly that can enable a riding lawn care vehicle to be switched between different operational modes. In this regard, for example, the mode switching assembly may include a series of brackets that can be selectively coupled to each other to alternately enable operation of the vehicle in a manual mode in which speed control inputs are provided directly by an operator that is physically present on the riding lawn care vehicle and a remote mode in which the operator may use a control device to provide speed control inputs from a remote location (i.e., not physically present on the riding lawn care vehicle).

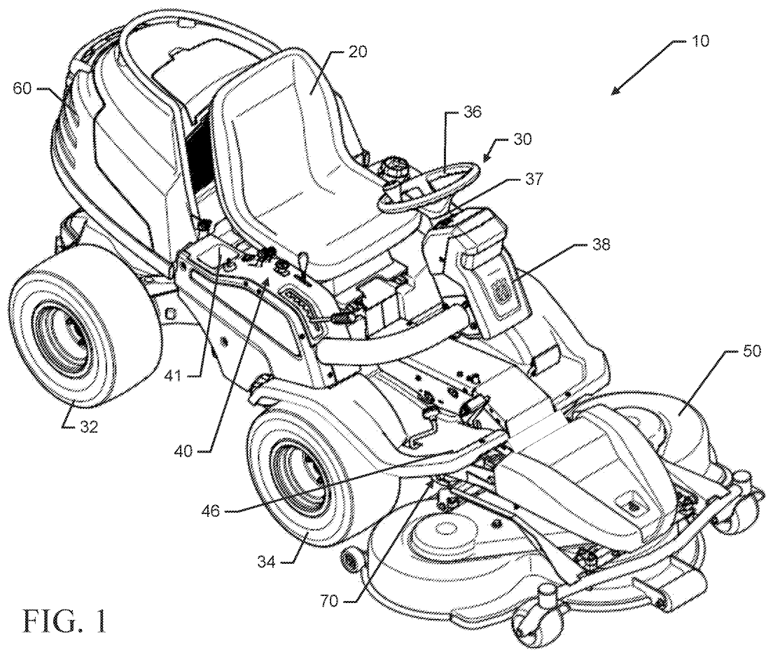

FIG. 1 illustrates a riding lawn care vehicle 10 as one example of a host device that may employ a mode switching assembly according to an example embodiment. The particular model shown, which includes front mounted accessories, and an articulated joint, is not necessarily the only model of host device or vehicle to which example embodiments may be applicable. As such, other models, including models with rear mounted accessories, accessories mounted between the front and rear wheels, walk-behind host devices, and devices that do not include articulation between front and rear sections could also be operated with the mode switching assembly as described herein.

In some embodiments, the riding lawn care vehicle 10 may include a seat 20 that may be disposed at a center, rear or front portion of the riding lawn care vehicle 10. The riding lawn care vehicle 10 may also include a steering assembly 30 (e.g., a steering wheel, handle bars, joystick(s) or the like) operably coupled to steerable wheels to which steering inputs are provided (e.g., rear wheels 32 in this case) of the riding lawn care vehicle 10 to allow the operator to steer the riding lawn care vehicle 10 via steering inputs that are communicated to the steerable wheels. In some examples, the steering assembly 30 may include steering levers that are operably coupled to the rear wheels 32 via a hydrostatic drive assembly. Since steering control is provided to the rear wheels 32 in this example, the front wheels 34 may not receive steering inputs in some embodiments. However, other steering arrangements are possible in other embodiments and the type of steering assembly 30 employed is not limiting to example embodiments. The operator may sit on the seat 20, which may be disposed to the rear of the steering assembly 30 to provide input for steering of the riding lawn care vehicle 10 via the steering assembly 30.

In an example embodiment, the steering assembly 30 may include a steering wheel 36 and a steering column 37. The steering column 37 may operably couple to additional steering assembly components or, in other embodiments, to the front wheels 34. Moreover, in some embodiments, the steering column 37 may extend into a steering console 38, which may provide a cover to improve the aesthetic appearance of the riding lawn care vehicle 10 by obscuring the view of various mechanical components associated with the steering assembly 30.

The riding lawn care vehicle 10 may also include additional control related components that may be disposed at a control panel 40 or user interface panel 41. The control related components may include levers, buttons, switches (soft or hard) and/or the like configured to provide control over certain functions or components such as a blade speed adjuster, a choke control, a cutting height adjuster, a cutting unit lifting controller, and/or the like. In some cases, the control panel 40 may also include controls for operation of the mode switching assembly of example embodiments described in greater detail below. The user interface panel 41 may be display via which touch screen controls may be provided, and the user interface panel 41 may be located at the control panel 40 (e.g., at a side of the seat 20), proximate to the steering wheel 36 (e.g., at the steering console 38), or at any other convenient location. A mode switch input to the mode switching assembly may therefore be provided via a soft key or switch at the user interface panel 41, or by physically pressing a button or moving a lever or switch at the control panel 40.

In some cases, one or more additional controllers, may be provided in the form of foot pedals that may sit proximate to a footrest 46 (which may include a portion on both sides of the riding lawn care vehicle 10 (e.g., on opposite sides of the steering console 38)) to enable the operator to rest his or her feet thereon while seated in the seat 20. These foot pedals may provide speed control for forward and/or backward operation, braking, cutting deck lifting or other functions. Other levers, operators or components are possible in other examples as well.

In some example embodiments, the steering assembly 30 may be embodied as an assembly of metallic or other rigid components that may be welded, fitted, bolted or otherwise operably coupled to each other and coupled to the wheels (rear wheels 32 in this example) of the riding lawn care vehicle 10 to which steering inputs are provided. For example, the steering assembly 30 may include or otherwise be coupled with a steering cable assembly or a system of mechanical linkages (e.g., pulleys, tie rods, cams, and/or other mechanical components) to translate rotational motion applied to the steering assembly 30 (and more particularly to the steering wheel 36) into directional inputs to orient the wheels accordingly. Other steering control systems may be employed in some alternative embodiments.

The riding lawn care vehicle 10 may also include, or be configured to support attachment of, a cutting deck 50 having at least one cutting blade mounted therein. The cutting deck 50 may be a removable attachment that may be positioned in front of the front wheels 34 in a position to enable the operator to cut grass using the cutting blades when the cutting blades are rotated below the cutting deck 50 and the cutting deck 50 is in a cutting position. When operating to cut grass, some example embodiments may provide that the grass clippings may be captured by a collection system, mulched, or expelled from the cutting deck 50 (e.g., via a discharge that may be directed to a side or rear of the cutting deck and/or riding lawn care vehicle 10).

In some embodiments, the cutting deck 50 may be replaced by other working attachments to change the configuration of the riding lawn care vehicle 10 and correspondingly change the tasks that may be performed by the riding lawn care vehicle 10. Thus, for example, a plow blade or snow blower attachment may be provided to convert the riding lawn care vehicle 10 into a snow removal device. Alternatively, a tiller attachment may be provided to convert the riding lawn care vehicle 10 into a ride-on or remote control operable tiller. Other attachments and configurations are also possible such as a sweeper, brush cutter, or the like. In each case, the different type of attachment may be considered to be a respective different type of accessory that can be powered by the riding lawn care vehicle 10 (as one example host device).

In the pictured example embodiment of FIG. 1, an engine or other power unit (e.g., a battery and electric motor) of the riding lawn care vehicle 10 is disposed in a power unit compartment 60 that is behind a seated operator in a rear portion of the riding lawn care vehicle 10. However, in other example embodiments, the power unit could be in different positions such as in front of or below the operator. In some embodiments, the power unit may be operably coupled to one or more of the wheels of the riding lawn care vehicle 10 in order to provide drive power for the riding lawn care vehicle 10. In some embodiments, the power unit may be capable of powering two wheels, while in others, the power unit may power all four wheels of the riding lawn care vehicle 10. Moreover, in some cases, the power unit may manually or automatically shift between powering either some wheels or all four wheels of the riding lawn care vehicle 10.

The power unit, the steering assembly 30, the cutting deck 50, the seat 20 and other components of the riding lawn care vehicle 10 may be operably connected (directly or indirectly) to a frame of the riding lawn care vehicle 10. The frame may be a rigid structure configured to provide support, connectivity and interoperability functions for various ones of the components of the riding lawn care vehicle 10. In some embodiments, the frame may be split or articulated such that, for example, the front wheels 34 are disposed on an opposite portion of the frame than the portion of the frame on which the rear wheels 32 are disposed with respect to an articulated joint in the frame. In some embodiments, the frame may include or be operably coupled to an attachment frame 70. In this example, the attachment frame 70 may be configured to enable at least some of the attachments or accessories that can be attached thereto to be rotated from the operating position (e.g., the cutting position for the cutting deck 50) to a maintenance position at which a plane in which the cutting deck 50 of FIG. 1 is rotated greater than about 45 degrees (and in some cases 90 degrees or more).

In some embodiments, the power unit may include a hydraulic pump that controls power output to various accessories and/or the wheels (32 and 34). In such cases, the hydraulic pump may be controlled via an input shaft that lies on an axis, and rotation of the input shaft about the axis may directly translate to changes to the power output of the hydraulic pump. Example embodiments may provide for the mode switching assembly to include an output bracket that interacts with the input shaft of the hydraulic pump in both remote and manual modes of operation. However, example embodiments may alter which one of multiple possible input brackets is selectively operably coupled to the output bracket. Thus, for example, the mode switching assembly of an example embodiment may include multiple input brackets that are capable of selection to determine which one will be coupled to the output bracket. One input bracket may be associated with the manual mode, and another may be associated with the remote mode.

As used herein, the term “bracket” is meant to convey an intermediate component or member that is intermediate between other components or members to operably couple (temporarily or permanently) such other components or members to each other. The mode switching assembly makes such operable coupling of components temporary, and selective so that it can be changed to match the operator's desires. Meanwhile, the term “actuator” refers to a powered control device that receives an input from a power source (e.g., an electrical input signal), and generates movement of the control device that in turn operably couples such movement to another device or component.

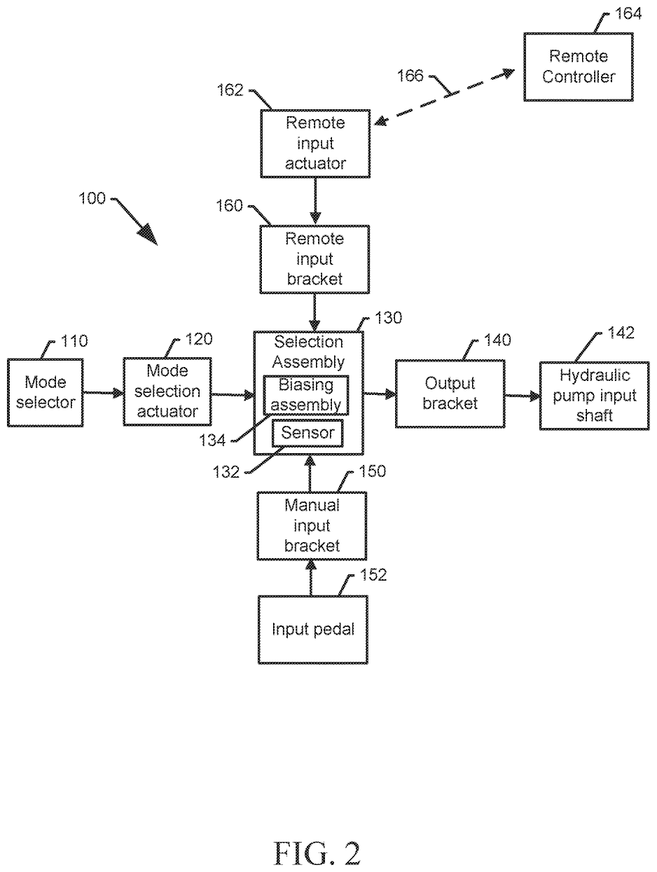

FIG. 2 illustrates a block diagram of a mode switching assembly 100 according to an example embodiment. In this regard, as shown in FIG. 2, the mode switching assembly 100 may include a mode selector 110 that is operable by the operator (or driver) of the riding lawn care vehicle 10. In an example embodiment, the mode selector 110 may be located at the control panel 40, user interface panel 41, or other accessible portion of the riding lawn care vehicle 10. Movement, selection or any other activation of the mode selector 110 may be communicated to a mode selection actuator 120. The mode selection actuator 120 may be an electrical actuator that regulates positioning of components of a selection assembly 130 that dictates what driving input will drive the output of the selection assembly 130 based on the positioning of the mode selector 110 (and corresponding action of the mode selection actuator 120). A position of the selection assembly 130 may be sensed or monitored by a sensor 132. The selection assembly 130 may also include a biasing assembly 134, which may bias the selection assembly into a particular one of the modes (manual or remote).

In an example embodiment, as shown in the figures that follow, the selection assembly 130 may be a series of three brackets that rotate about a common axis. One of the three brackets may be an output bracket 140, and the other two brackets may each be alternative driving input brackets. The selection assembly 130 may enable a selected one of the driving input brackets to be coupled to the output bracket 140. Movement of the output bracket 140 then drives a hydraulic pump input shaft 142, which translates this input to a hydraulic pump that drives the riding lawn care vehicle 10.

The driving input brackets may include a manual input bracket 150, which is operably coupled to an input pedal 152 (e.g., a throttle or gas pedal), which is operable by an operator from the seat 20 of the riding lawn care vehicle 10. The driving input brackets may also include a remote input bracket 160. The remote input bracket 160 may be operably coupled to a remote input actuator 162. The remote input actuator 162 may generate a driving output to drive the remote input bracket 160 based on control signaling provided from a remote controller 164. The remote controller 164 may provide the control signaling via a wireless communication link 166 (shown in dashed lines in FIG. 2 to illustrate its wireless nature). Thus, it should be understood that the remote controller 164 includes an antenna and other circuitry to enable the control signaling to be sent to the remote input actuator 162, which may itself include (or be operably coupled to) an antenna for receiving the control signaling. The remote controller 164 may also include a user interface for defining control inputs that are converted to the control signaling. The user interface may include a joystick or other input device and in some cases may also include a display or screen.

When the mode selector 110 is positioned or otherwise activated for remote operation, the mode selection actuator 120 may position the selection assembly 130 to operably couple the remote input bracket 160 to the output bracket 140. When so arranged, the control signaling provided at the remote controller 164 may be communicated to the remote input actuator 162 and cause corresponding movement of the remote input actuator 162. The remote input actuator 162 causes corresponding movement of the remote input bracket 160, which is then translated via the selection assembly 130 to the output bracket 140 to drive the hydraulic pump input shaft 142 based on the control signaling provided at the remote controller 164.

When the mode selector 110 is instead positioned or otherwise activated for manual operation, the mode selection actuator 120 may position the selection assembly 130 to operably couple the manual input bracket 150 to the output bracket 140. When so arranged, the manual inputs provided at the input pedal 152 by an operator located in the seat 20 may be communicated to the manual input bracket 150. The corresponding movement of the manual input bracket 150 is then translated via the selection assembly 130 to the output bracket 140 to drive the hydraulic pump input shaft 142 based on the manual inputs provided at the input pedal 152.

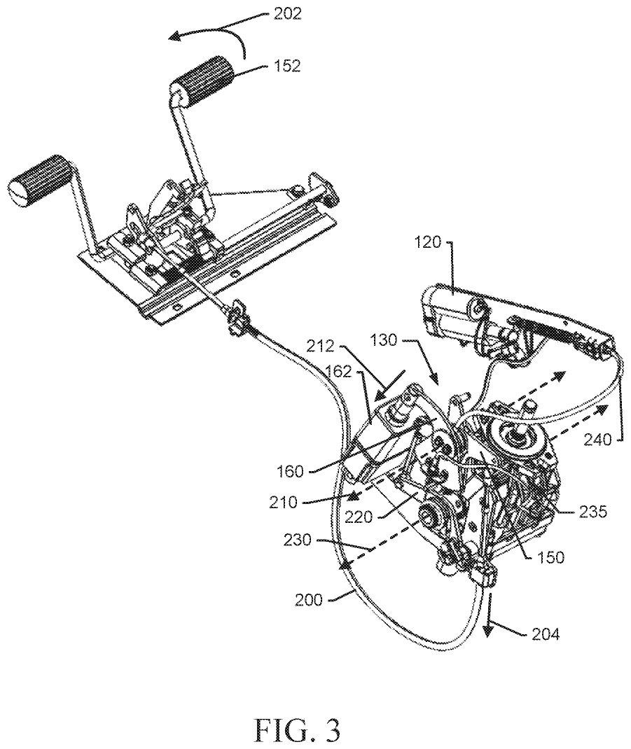

As can be appreciated from the descriptions above, the components of the mode switching assembly 100 may take various different forms. FIG. 3 illustrates one such example of some forms that the components may take. In this regard, FIG. 3 illustrates input pedal 152 operably coupled to selection assembly 130 via the manual input bracket 150. The operable coupling in this example is provided by a flexible wire or cable 200. However, a link or rod may provide the operable coupling in alternative embodiments. When the input pedal 152 is depressed in the direction of arrow 202, the cable 200 may be pulled in the direction of arrow 204 correspondingly repositioning the manual input bracket 150 by rotation about a selection assembly axis 210.

The remote input actuator 162 is shown in FIG. 3 as a linear actuator that is operably coupled to the remote input bracket 160. The remote controller 164 is not shown in FIG. 3, but inputs provided thereby are communicated to the remote input actuator 162 to cause corresponding movement of the remote input bracket 160. Thus, for example, if the linear actuator of the remote input actuator 162 moves in the direction of arrow 212, the remote input bracket 160 will rotate about the selection assembly axis 210 in the same direction.

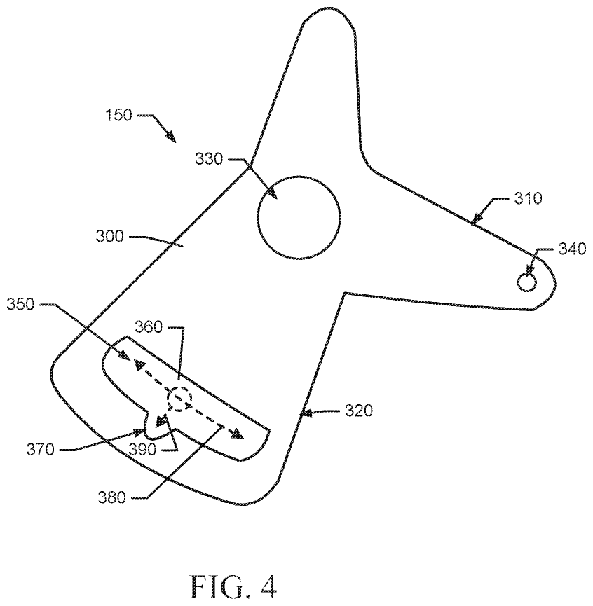

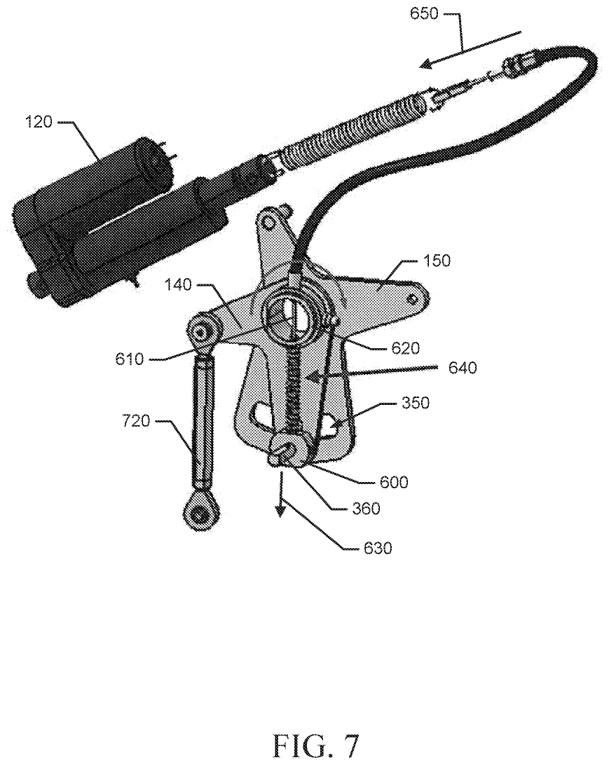

Notably, movement of the remote input bracket 160 and the manual input bracket 150 could both occur simultaneously. However, only the movement of one of the remote input bracket 160 or the manual input bracket 150 will be used for driving rotation of the hydraulic pump input shaft 142, which is operably coupled to a hub 220 that rotates about a hydraulic pump input shaft axis 230 of hydraulic pump 235. As noted above, the one of the remote input bracket 160 or the manual input bracket 150 that drives rotation of the hydraulic pump input shaft 142 is determined by the selection assembly 130, which is in turn controlled by mode selection actuator 120. More detailed discussion of the operation of the selection assembly 130 will be provided in reference to FIGS. 4-10. More specifically, FIGS. 4-6 illustrate side views of the manual input bracket 150, the remote input bracket 160, and the output bracket 140 in accordance with an example embodiment. FIGS. 7-10 illustrate various views of the manual input bracket 150, the remote input bracket 160, and the output bracket 140 interacting to define different modes.

Turning first to FIG. 4, the manual input bracket 150 may include a body portion 300, an input arm 310 and an output arm 320. The input arm 310 and the output arm 320 extend radially away from a pivot aperture 330 through which a mounting shaft that is coaxial with the selection assembly axis 210 is mounted. The input arm 310 also includes a receiving aperture 340 at which the cable 200 is attached to the input arm 310. The output arm 320 includes a slot portion 350 inside which a pivot pin 360 can move from side to side without engaging the output arm 320. However, the slot portion 350 further includes a pin receiver 370, which extends radially outwardly (away from the pivot aperture 330) to receive, catch and/or hold the pivot pin 360 when the selection assembly 130 is in a manual mode position. When the selection assembly 130 is in the remote mode position, the pivot pin 360 is separated from the pivot aperture 330 by the distance shown in FIG. 4, and can move side to side freely in a direction substantially tangential to the radial direction as shown by arrow 380. However, when the selection assembly 130 is in the manual mode position, the pivot pin 360 moves radially outwardly in the direction of arrow 390 and is received and retained in the pin receiver 370.

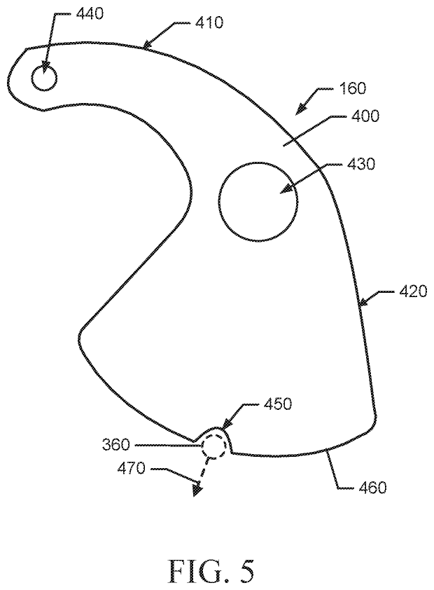

The remote input bracket 160 of FIG. 5 has a body portion 400, and input arm 410 and an output arm 420. The input arm 410 and the output arm 420 extend radially away from a pivot aperture 430 through which the mounting shaft that is coaxial with the selection assembly axis 210 is mounted. Thus, the pivot aperture 430 of the remote input bracket 160 is coaxial with the pivot aperture 330 of the manual input bracket 150. The input arm 410 also includes a receiving aperture 440 at which a link may be attached, and the link may be operably coupled to the remote input actuator 162. However, in some cases, the input arm 410 may be directly connected to the remote input actuator 162. The output arm 420 includes a receiving slot 450 formed at an external edge 460 of a distal end of the output arm 420. The receiving slot 450 may receive, catch and/or hold the pivot pin 360 when the selection assembly 130 is in the remote mode position. Thus, for example, when the selection assembly 130 is in the remote mode position, the pivot pin 360 is held in the receiving slot 450 (as shown in FIG. 5) and carries the pivot pin 360 according to the movement of the remote input bracket 160 about the pivot aperture 430. However, when the selection assembly 130 is in the manual mode position, the pivot pin 360 moves in the direction of arrow 470 and is no longer received and retained in the receiving slot 450.

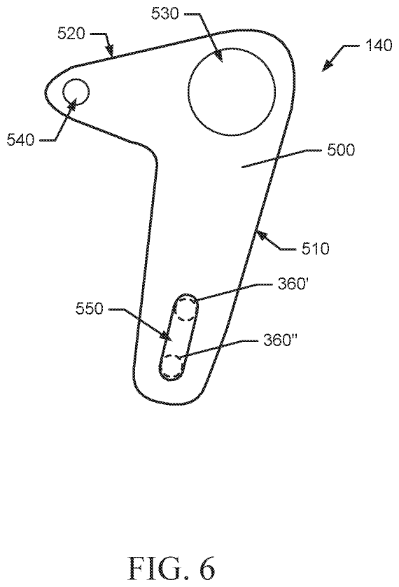

The output bracket 140 of FIG. 6 has a body portion 500, and input arm 510 and an output arm 520. The input arm 510 and the output arm 520 extend radially away from a pivot aperture 530 through which the mounting shaft that is coaxial with the selection assembly axis 210 is mounted. Thus, the pivot aperture 530 of the output bracket 140 is coaxial with the pivot apertures 330 and 430 of the manual input bracket 150 and remote input bracket 160, respectively. The output arm 520 also includes a receiving aperture 540 at which an output link may be attached, and the output link may be operably coupled to the hub 220 to reposition the hub 220 based on rotation of the output bracket 140 about the selection assembly axis 210. The input arm 510 includes a carrying slot 550 formed proximate to a distal end of the input arm 510, and extending in a radially outward direction (relative to the selection assembly axis 210). The carrying slot 550 allows the pivot pin 360 to move freely radially inwardly and outwardly therein. FIG. 6 shows pivot pin 360′ (corresponding to the remote mode position) at a position in which the pivot pin 360 is retained in the receiving slot 450 of the remote input bracket 160. As noted above, this occurs when the selection assembly 130 is in the remote mode position. FIG. 6 also shows pivot pin 360″ (corresponding to the manual mode position) at a position in which the pivot pin 360 is retained in pin receiver 370 of the manual input bracket 150. As noted above, this occurs when the selection assembly 130 is in the manual mode position. In either mode, the movement of the pivot pin in the direction of arrow 560 causes corresponding rotation of the output bracket 140. The only difference therefore is which one of either the manual input bracket 150 or the remote input bracket 160 is driving the output bracket 140 rotation through connection with the pivot pin 360.

FIG. 7 illustrates how the pivot pin 360 may be repositioned according to an example embodiment. In this regard, FIG. 7 illustrates operation of the selection assembly 130, of which the pivot pin 360 forms a portion. The pivot pin 360 may be mounted on a carrier 600 that is operably coupled to the mode selection actuator 120 via wire 610 that, in this example, passes through the mounting shaft 620 on which the remote input bracket 160, the manual input bracket 150, and the output bracket 140 are rotatably mounted. The carrier 600 may be biased downward or in the direction of arrow 630 in FIG. 7 by spring 640 (which may be the biasing assembly 134, or a component thereof). When the mode selection actuator 120 operates to transition to the remote mode position (i.e., corresponding to the pivot pin 360′ position of FIG. 6), the mode selection actuator 120 pulls on the wire 610 in the direction of arrow 650. The wire 610 then pulls the carrier 600 and pivot pin 360 upward and opposite the direction of arrow 630 to remove the pivot pin 360 from the pin receiver 370 and pull the pivot pin 360 into the receiving slot 450 (against and overcoming the biasing of the spring 640). Thus, the pivot pin 360 transitions (i.e., by up and down movement inside the carrying slot 550 of FIG. 6) from the position of pivot pin 360″ to the position of pivot pin 360′ in FIG. 6. When the pivot pin 360 is transitioned into and retained in the receiving slot 450 of the remote input bracket 160, all movement of the remote input bracket 160 (from the remote input actuator 162 and remote controller 164) is transferred to the output bracket 140.

Meanwhile, when the wire 610 is not pulled (i.e., when the mode selection actuator 120 is not actuated), the spring 640 will bias the carrier 600 downward and remove the pivot pin 360 from the receiving slot 450 of the remote input bracket 160 and instead seat the pivot pin 360 into the pin receiver 370 of the manual input bracket 150. When the pivot pin 360 is transitioned into and retained in the pin receiver 370 of the manual input bracket 150, all movement of the manual input bracket 150 (from the input pedal 152) is transferred to the output bracket 140.

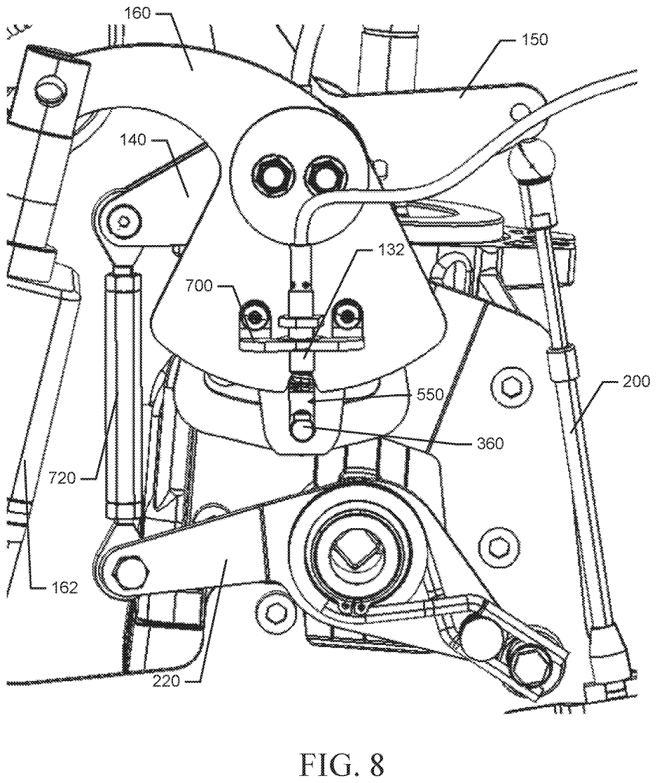

FIG. 8 illustrates a closer view of the selection assembly 130 and brackets. In this regard, FIG. 8 shows the remote input actuator 162 operably coupled to the remote input bracket 160. A sensor bracket 700 houses the sensor 132, which may detect a position of the pivot pin 360. FIG. 8 also illustrates the manual input bracket 150 and cable 200 via which manual inputs are provided. The output bracket 140 is also visible in FIG. 8, and it can be seen that the pivot pin 360 is in the downward, or manual mode position. This means that movement of the manual input bracket 150 responsive to movement of the cable 200 will be translated to the output bracket 140 via the pivot pin 360 and carrying slot 550. Movement of the output bracket 140 may then be translated to a linkage rod (e.g., output link 720), which is operably coupled to the hub 220 and controls speed of the hydraulic pump.

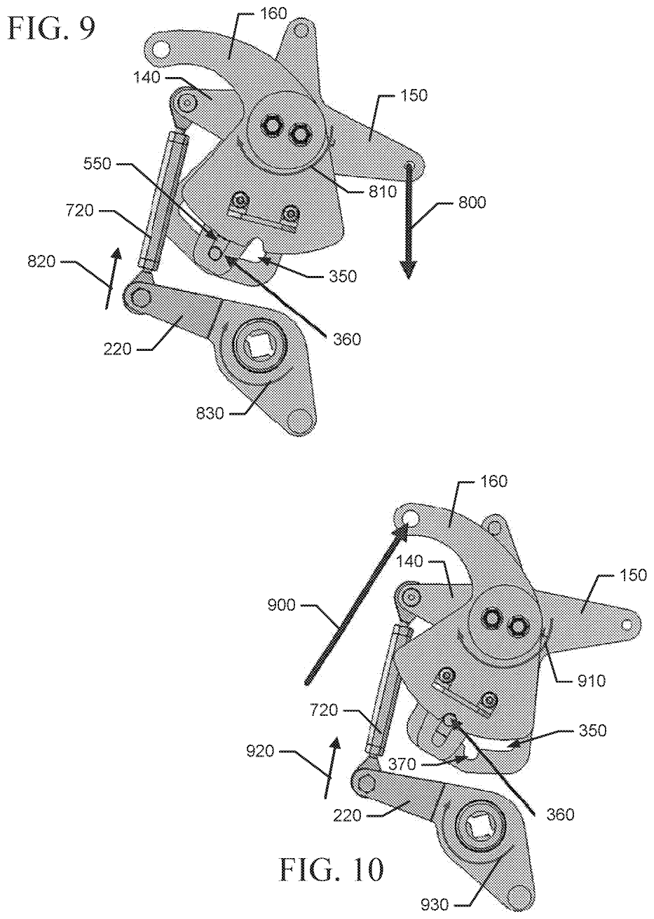

FIG. 9 demonstrates manual mode operation. In this regard, since the pivot pin 360 is in the manual mode position (i.e., downward), the pivot pin 360 connects the manual input bracket 150 to the output bracket 140. Accordingly, if the manual input bracket 150 is pulled downward in the direction of arrow 800, the manual input bracket 150 will rotate in the direction of arrow 810 thereby lifting the output link 720 upward (in the direction of arrow 820) causing the hub 220 to rotate in the direction of arrow 830. Movement of the manual input bracket 150 upward would cause opposite directional movements to those described above. Notably, since the pivot pin 360 is biased downward, any loss of electrical power will cause the selection assembly 130 to default to the condition of FIG. 9, and therefore default to manual mode operation.

FIG. 10 demonstrates remote mode operation. In this regard, since the pivot pin 360 is in the remote mode position (i.e., upward), the pivot pin 360 connects the remote input bracket 160 to the output bracket 140. Accordingly, if the remote input bracket 160 is pushed upward in the direction of arrow 900, the remote input bracket 160 will rotate in the direction of arrow 910 thereby lifting the output link 720 upward (in the direction of arrow 920) causing the hub 220 to rotate in the direction of arrow 930. Movement of the remote input bracket 160 downward would cause opposite directional movements to those described above.

Some embodiments of the invention provide a mode switching assembly that switches a riding lawn care vehicle between a manual mode of operation and a remote mode of operation. The mode switching assembly may include a manual input bracket that receives a manually applied speed control from a local operator at the riding lawn care vehicle, a remote input bracket that receives a remotely applied speed control from a remote operator relative to the riding lawn care vehicle, an output bracket that drives a speed of the riding lawn care vehicle based on an input to a selected one of the manual input bracket or the remote input bracket, and a selection assembly operably coupling the selected one of the manual input bracket or the remote input bracket to the output bracket to define the manual and remote modes of operation. The selection assembly may include a biasing assembly to bias the selection assembly such that, by default, the output bracket is operably coupled to the manual input bracket.

In some embodiments, the mode switching assembly (or a riding lawn care vehicle including such assembly) may include additional, optional features, and/or the features described above may be modified or augmented. Some examples of modifications, optional features and augmentations are described below. It should be appreciated that the modifications, optional features and augmentations may each be added alone, or they may be added cumulatively in any desirable combination. In this regard, for example, the manual input bracket may be operably coupled to an input pedal of the riding lawn care vehicle by a cable such that, in the manual mode of operation, movement of the input pedal is transferred to the output bracket via the selection assembly, the cable and the input pedal. In an example embodiment, the remote input bracket may be operably coupled to a remote input actuator, and the remote input actuator may be actuated under control of the remote operator by a remote controller to overcome the biasing assembly and transition the selection assembly to the remote mode of operation by connecting the remote input bracket to the output bracket. In some cases, the remote controller may communicate with the remote input actuator via a wireless connection. In an example embodiment, the manual input bracket, the remote input bracket and the output bracket may each be rotatably mounted onto a mounting shaft, and the selection assembly may include a pivot pin that engages the output bracket to only one of the manual input bracket or the remote input bracket based on a position of the pivot pin to define the manual mode of operation and the remote mode of operation, respectively. In some cases, the output bracket may include a carrying slot inside which the pivot pin is movable, the pivot pin may move in a radial direction between a manual mode position and a remote mode position in the carrying slot, and the pivot pin may move in a direction tangential to the radial direction responsive to movement of the manual input bracket or the remote input bracket in the manual mode position and remote mode position, respectively. In an example embodiment, the manual input bracket may include a slot portion extending in the direction tangential to the radial direction and a pin receiver extends from the slot portion in the radial direction to catch and receive the pivot pin in the manual mode position. In some cases, the remote input bracket may include a receiving slot extending in the radial direction at an edge of a distal end of the remote input bracket to catch and receive the pivot pin in the remote mode position. In an example embodiment, a sensor may be disposed proximate to the pivot pin to determine a location of the pivot pin and indicate whether the riding lawn care vehicle is in the manual mode of operation or the remote mode of operation based on the location of the pivot pin. In some cases, the pivot pin may be operably coupled to a carrier that is urged away from a common axis of the manual input bracket, the remote input bracket and the output bracket by a spring of the biasing assembly, and the output bracket may be operably coupled to a hub via a linkage rod to rotate a hydraulic pump input shaft responsive to movement of the output bracket.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A mode switching assembly for switching a riding lawn care vehicle between a manual mode of operation and a remote mode of operation, the mode switching assembly comprising:
a manual input bracket that receives a manually applied speed control from a local operator at the riding lawn care vehicle
a remote input bracket that receives a remotely applied speed control from a remote operator relative to the riding lawn care vehicle
an output bracket that drives a speed of the riding lawn care vehicle based on an input to a selected one of the manual input bracket or the remote input bracket and
a selection assembly operably coupling the selected one of the manual input bracket or the remote input bracket to the output bracket to define the manual and remote modes of operation,
wherein the selection assembly comprises a biasing assembly to bias the selection assembly such that, by default, the output bracket is operably coupled to the manual input bracket.

2. The mode switching assembly of claim 1, wherein the manual input bracket is operably coupled to an input pedal of the riding lawn care vehicle by a cable such that, in the manual mode of operation, movement of the input pedal is transferred to the output bracket via the selection assembly, the cable and the input pedal.

3. The mode switching assembly of claim 1, wherein the remote input bracket is operably coupled to a remote input actuator, and
wherein the remote input actuator is actuated under control of the remote operator by a remote controller to overcome the biasing assembly and transition the selection assembly to the remote mode of operation by connecting the remote input bracket to the output bracket.

4. The mode switching assembly of claim 3, wherein the remote controller communicates with the remote input actuator via a wireless communication link.

5. The mode switching assembly of claim 1, wherein the manual input bracket, the remote input bracket and the output bracket are each rotatably mounted onto a mounting shaft, and
wherein the selection assembly comprises a pivot pin that engages the output bracket to only one of the manual input bracket or the remote input bracket based on a position of the pivot pin to define the manual mode of operation and the remote mode of operation, respectively.

6. The mode switching assembly of claim 5, wherein the output bracket comprises a carrying slot inside which the pivot pin is movable,
wherein the pivot pin moves in a radial direction between a manual mode position and a remote mode position in the carrying slot, and
wherein the pivot pin moves in a direction tangential to the radial direction responsive to movement of the manual input bracket or the remote input bracket in the manual mode position and remote mode position, respectively.

7. The mode switching assembly of claim 6, wherein the manual input bracket comprises a slot portion extending in the direction tangential to the radial direction and a pin receiver extends from the slot portion in the radial direction to catch and receive the pivot pin in the manual mode position.

8. The mode switching assembly of claim 6, wherein the remote input bracket comprises a receiving slot extending in the radial direction at an edge of a distal end of the remote input bracket to catch and receive the pivot pin in the remote mode position.

9. The mode switching assembly of claim 5, wherein a sensor is disposed proximate to the pivot pin to determine a location of the pivot pin and indicate whether the riding lawn care vehicle is in the manual mode of operation or the remote mode of operation based on the location of the pivot pin.

10. The mode switching assembly of claim 5, wherein the pivot pin is operably coupled to a carrier that is urged away from a common axis of the manual input bracket the remote input bracket and the output bracket by a spring of the biasing assembly, and
wherein the output bracket is operably coupled to a hub via a linkage rod to rotate a hydraulic pump input shaft responsive to movement of the output bracket.

11. A riding lawn care vehicle comprising:
a frame to which wheels of the riding lawn care vehicle are attachable;
a steering assembly operably coupled to one or more of the wheels of the riding lawn care vehicle to provide steering inputs to the one or more of the wheels by an operator of the riding lawn care vehicle; and
a mode switching assembly for switching the riding lawn care vehicle between a manual mode of operation and a remote mode of operation, the mode switching assembly comprising:
a manual input bracket that receives a manually applied speed control from a local operator at the riding lawn care vehicle;
a remote input bracket that receives a remotely applied speed control from a remote operator relative to the riding lawn care vehicle;
an output bracket that drives a speed of the riding lawn care vehicle based on an input to a selected one of the manual input bracket or the remote input bracket; and
a selection assembly operably coupling the selected one of the manual input bracket or the remote input bracket to the output bracket to define the manual and remote modes of operation,
wherein the selection assembly comprises a biasing assembly to bias the selection assembly such that, by default, the output bracket is operably coupled to the manual input bracket.

12. The riding lawn care vehicle of claim 11, wherein the manual input bracket is operably coupled to an input pedal of the riding lawn care vehicle by a cable such that, in the manual mode of operation, movement of the input pedal is transferred to the output bracket via the selection assembly, the cable and the input pedal.

13. The riding lawn care vehicle of claim 11, wherein the remote input bracket is operably coupled to a remote input actuator, and
wherein the remote input actuator is actuated under control of the remote operator by a remote controller to overcome the biasing assembly and transition the selection assembly to the remote mode of operation by connecting the remote input bracket to the output bracket.

14. The riding lawn care vehicle of claim 13, wherein the remote controller communicates with the remote input actuator via a wireless communication link.

15. The riding lawn care vehicle of claim 11, wherein the manual input bracket, the remote input bracket and the output bracket are each rotatably mounted onto a mounting shaft, and
wherein the selection assembly comprises a pivot pin that engages the output bracket to only one of the manual input bracket or the remote input bracket based on a position of the pivot pin to define the manual mode of operation and the remote mode of operation, respectively.

16. The riding lawn care vehicle of claim 15, wherein the output bracket comprises a carrying slot inside which the pivot pin is movable,
wherein the pivot pin moves in a radial direction between a manual mode position and a remote mode position in the carrying slot, and
wherein the pivot pin moves in a direction tangential to the radial direction responsive to movement of the manual input bracket or the remote input bracket in the manual mode position and remote mode position, respectively.

17. The riding lawn care vehicle of claim 16, wherein the manual input bracket comprises a slot portion extending in the direction tangential to the radial direction and a pin receiver extends from the slot portion in the radial direction to catch and receive the pivot pin in the manual mode position.

18. The riding lawn care vehicle of claim 16, wherein the remote input bracket comprises a receiving slot extending in the radial direction at an edge of a distal end of the remote input bracket to catch and receive the pivot pin in the remote mode position.

19. The riding lawn care vehicle of claim 15, wherein a sensor is disposed proximate to the pivot pin to determine a location of the pivot pin and indicate whether the riding lawn care vehicle is in the manual mode of operation or the remote mode of operation based on the location of the pivot pin.

20. The riding lawn care vehicle of claim 15, wherein the pivot pin is operably coupled to a carrier that is urged away from a common axis of the manual input bracket, the remote input bracket and the output bracket by a spring of the biasing assembly, and
wherein the output bracket is operably coupled to a hub via a linkage rod to rotate a hydraulic pump input shaft responsive to movement of the output bracket.
